(19) United States
(12) Patent Application Publication
(10) Pub. No.: US 2005/0201458 A1
(43) Pub. Date: Sep. 15, 2005

(54) Image encoding system and method

(75) Inventor: Ning Lu, Mountain View, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Pinnacle Systems, Inc.

(21) Appl. No.: 10/800,378

(22) Filed: Mar. 12, 2004

(51) Int. Cl. H04N 11/04

(52) U.S. Cl. 375/240.1

(57) ABSTRACT

An image encoding system includes a processor and a memory device coupled to the processor. The processor is configured to receive input data containing image information, to generate encoded data based on a frequency domain transform of the input data, and to selectively generate an encoded reference based on a frequency domain transform of the input data. The system also includes a memory device coupled to the processor. The processor is further configured to store the generated encoded reference in the memory device when no encoded reference is available in the memory device and generate residue data representing the difference between the encoded data and the stored encoded reference when the encoded reference is available in the memory device.

### TECHNICAL FIELD

The present invention relates to image encoding and, more particularly, to image encoding systems and methods applicable to video encoding.

### BACKGROUND

Encoding is a process of transforming data, such as from one format to another. Data may be encoded, for example, to generate data compatible with another system or format, to pack or compress data, to compare the data with other data, and/or to improve security. For example, image information traditionally presented in an analog format is now often stored, processed, or transmitted in a digital format. Image information may include the image information of a single or multiple images, such as an electronic still picture, a document, or a group of images, such as video data.

The term “digital video” generally refers to video signals represented in a digital format. Digital video offers several advantages over traditional analog video, that is, video signals represented in an analog format. For example, recordings of digital video can be copied and re-copied indefinitely without significant loss of quality. Also, digital video may be compressed, thus requiring less storage space than analog recordings of the same or lesser picture quality.

To process data digitally, analog video data must first be converted to data of a digital format. Unfortunately, direct conversion of analog video having fast frame rates, many colors, and high resolution results in a large volume of digital video data, creating difficulties for storage and transmission. Many digital video systems, therefore, reduce the size of converted digital video via data compression techniques optimized for a particular application. An encoder may be used to transform digital data into an encoded, or compressed version. In contrast, a decoder may be used to transform compressed digital data in a reverse manner, thereby decompressing the encoded digital video. An encoder and a decoder, depending on their designs, are not limited to the applications described above and may perform data processing functions other than data compressing and decompressing.

Known formats for encoding digital video to reduce its volume are the “MPEG” (Moving Pictures Experts Group) formats. MPEG formats, including the MPEG-1, MPEG-2, and MPEG-4 formats, are based on industry standards to compress digital audio and digital video for use in terrestrial digital TV broadcasts, satellite TV broadcasts, DVDs, and video-conferencing applications. Depending on their applications, different MPEG formats or their variations may have different data rates and use different data-processing techniques.

Processing video signals to create MPEG-format signals, however, generally involves a complicated procedure that requires significant processing power and memory space. Thus, real-time encoding to provide compressed digital video in MPEG formats requires powerful and expensive encoding apparatus. Therefore, devices such as camcorders, digital cameras, wireless phones, or other portable devices may not provide real-time encoding capabilities because of their limited processing power and memories.

Various computing algorithms have been proposed to speed up image encoding processes. However, there still is a need in the art of image encoding to further speed up or simplify an image encoding process without significantly increasing the cost of an encoding device or impacting the quality of an encoded signal.

### SUMMARY OF THE INVENTION

Accordingly, embodiments consistent with the present invention may relate to encoding systems and methods that may obviate one or more of the limitations or disadvantages existed in the related art.

Embodiments consistent with the invention provide an MPEG-2 image encoding method. The method comprises receiving input data containing image information; generating encoded data based on a frequency domain transform of the input data; determining whether an encoded reference is available for use; generating residue data representing the difference between the encoded data and the encoded reference when the encoded reference is available; and storing the encoded data as an encoded reference when no encoded reference is available.

Embodiments consistent with the invention also provide an image encoding system. The system includes a processor configured to receive input data containing image information, to generate encoded data based on a frequency domain transform of the input data, and to selectively generate an encoded reference based on a frequency domain transform of the input data. The system also includes a memory device coupled to the processor. The processor is further configured to store the generated encoded reference in the memory device when no encoded reference is available in the memory device and generate residue data representing the difference between the encoded data and the stored encoded reference when the encoded reference is available in the memory device.

Embodiments consistent with the invention further provide a computer-readable medium. The computer-readable medium contains instructions for a computer to encode image information. In particular, the computer-readable medium instructs the computer to receive input data containing image information; to generate encoded data based on a frequency domain transform of the input data; to determine whether an encoded reference is available for use; to generate residue data representing the difference between the encoded data and the encoded reference when the encoded reference is available; and to store the encoded data as an encoded reference when no encoded reference is available.

### BRIEF DESCRIPTION OF THE DRAWINGS

The accompanying drawings, which are incorporated in and constitute a part of this specification, illustrate several embodiments consistent with the invention and together with the description, serve to explain the principles of the invention. In the drawings:

FIG. 1 is a functional block diagram of an image encoding system consistent with the principles of the present invention;

FIG. 2 is a flow chart illustrating one exemplary image encoding method; and

FIG. 3 is a flow chart illustrating another exemplary image encoding method consistent with the principles of the present invention.

### DETAILED DESCRIPTION

Reference will now be made in detail to the embodiments of the invention, examples of which are illustrated with reference to the accompanying drawings. Wherever possible, the same reference numbers will be used throughout the drawings to refer to the same or like parts.

A method or a system consistent with the invention may encode image data, including digital video data. A frequency domain transform may be used to create encoded data from input data containing image information. The encoded data can be an encoded reference or be compared with an existing encoded reference. A method or a system consistent with the invention may reduce the complexity of an image encoding process, expedite image encoding, or allow real-time image encoding. Furthermore, a method or a system consistent with the invention may achieve one or more of those characteristics without significantly affecting the image quality of encoded data.

Without limiting the scope the invention, an exemplary encoding process of the MPEG-2 format will be described below. An image in the form of a video frame is composed of a large number of picture elements, or “pixels.” The group of pixels forming the entire frame can be divided into “macroblocks” each consisting of a 16×16 pixel square. The macroblocks, in turn, can be divided into “blocks” each consisting of an 8×8 pixel square.

Each pixel can be represented by signal values specifying the brightness and color of the individual pixel. In the MPEG-2 format, these signal values include a brightness, or luminance, component Y and two color, or chrominance, components U and V. The Y, U, and V components are similar in concept to the well-known R, G, and B components, but provide better compression.

For full resolution, signal values representing the entire frame would consist of a set of separate Y, U, and V component values for each pixel in the frame. However, because the human eye is less sensitive to color than brightness, the MPEG-2 standard provides for representation of frames by a set of signal values in which the number of Y component values is equal to the number of pixel in the frame and the number of U and V component values can be less than the number of pixels in the frame. Specifically, MPEG-2 provides for a 4:2:2 format in which color resolution is at 50% of luminance resolution, and a 4:2:0 format in which color resolution is at 25% of luminance resolution.

In one embodiment, a macroblock of pixels can be represented by a group of values consisting of four 8×8 sets of values representing the Y components of the macroblock and either four, two, or one 8×8 set of values representing each of the U and V components of the macroblock, depending on the chrominance resolution. Thus, each macroblock of pixels in a frame can be represented by a total of either twelve, eight, or six 8×8 sets of component values.

During image encoding, a video sequence having a series of images may be divided into multiple sections, also known as a group of pictures (“GOP”), each having a plurality of frames. A GOP is encoded as frames of three different types: I, P, or B. An I-frame is coded independently, using only data contained within the frame itself and without reference to other frames. P- and B-frames are generated by coding the differences between the data in the frame and one or more other frames. In particular, a P-frame references to a preceding frame and contains predictions from temporally preceding I- or P-frames in the sequence. A B-frame (“bidirectionally predictive-coded frame”) may reference to the frame immediately before and the frame immediately after the current frame. In other words, a B-frame may obtain predictions from the nearest preceding and upcoming I- or P-frames.

The frame type may be predefined by the relative position of a frame in a video sequence. A typical GOP may consist of p×q frames, where p and q are constants, and be described as (p, q)-GOP. For example, a GOP may consist of an I-frame followed by q-1 B-frames, and then followed by p-1 repeats of q-1 B-frames, each led by a P-frame. Accordingly, a (3,5)-GOP of 15 frames may have the following frame sequence:

I, B, B, P, B, B, P, B, B, P, B, B, P, B, and B.

In summary, a video sequence may be divided into multiple GOPs, each GOP having a group of frames. Each frame consists of a combination of macroblocks, which consists of a combination of blocks. Each macroblock or block may be represented by values consisting of either intra-block or inter-block codes. Intra-block codes are codes that do not reference to another macroblock or block. In contrast, inter-block codes may represent how one macroblock or block differs from another macroblock or block, particularly from nearby macroblock or block in adjacent frames, and, therefore, reference to the codes of another macroblock or block.

For example, a set of 8×8 component values may be derived from the image data of an 8×8 block. These values are then transformed into discrete cosine transform (“DCT”) coefficients, quantized, and then Huffman-coded to form the intra-block codes. In contrast, a set of 8×8 inter-block codes may be predicted from either the latest I- or P-frame before the current frame (backward), or from the nearest I- or P-frame after the current frame (forward), or from both (bidirectional). The inter-block codes are then transformed into DCT coefficients and (optionally) Huffman coded. As a result, a macroblock of an I-frame may be coded in intra-block codes. A macroblock of a P-frame may be coded in forward or backward inter-block codes. And a macroblock of a B-frame may be coded in bidirectional inter-block codes.

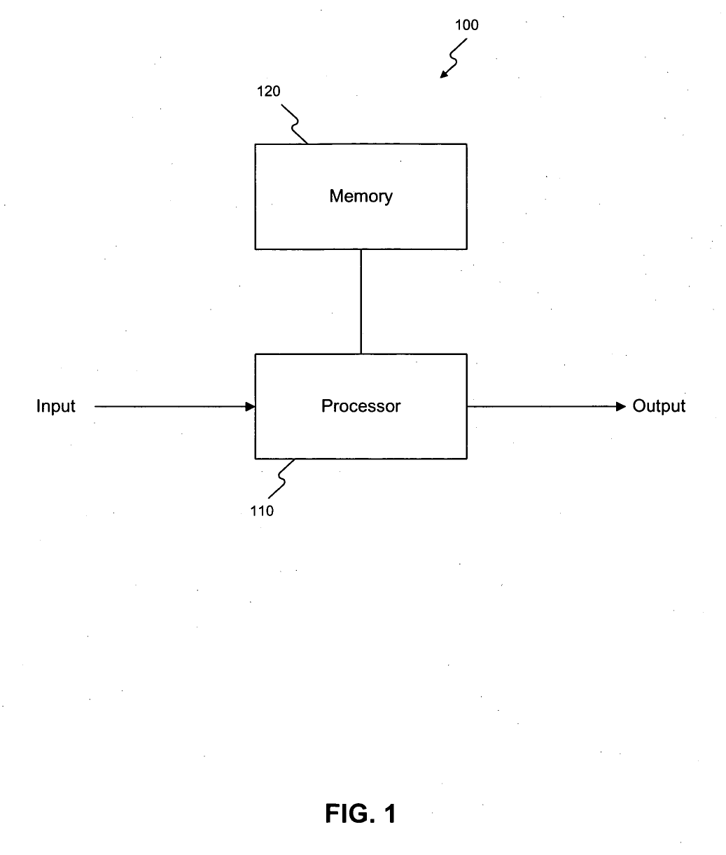

To encode image data, an image encoding system may be used. FIG. 1 shows a functional block diagram illustrating an embodiment of an image encoding system 100 consistent with the present invention. As shown in FIG. 1, system 100 comprises a processor 110 and a memory 120 operatively coupled with processor 110. System 100 may be a part of any image encoding or processing system, such as a computer, a portable computing device, a wireless phone, a camcorder, or a digital camera. For example, system 100 may contain an embedded chip and a memory with instructions coded therein or a processing system instructed by a software to encode an image.

Inside system 100, processor 110 may be a processing device configured to execute instructions and encode images in manners consistent with the invention. Memory 120 may be one or more memory devices that store data, as well as software codes, control codes, or both. Therefore, processor 110 may access the data and execute the control codes stored in memory 120. Although FIG. 1 shows only one memory, memory 120 may comprise any number of and any combination of memories. For example, memory 120 may comprise one or more of RAMs (random access memories), ROMs (read-only memories), magnetic storages, optical storages, and organic storages.

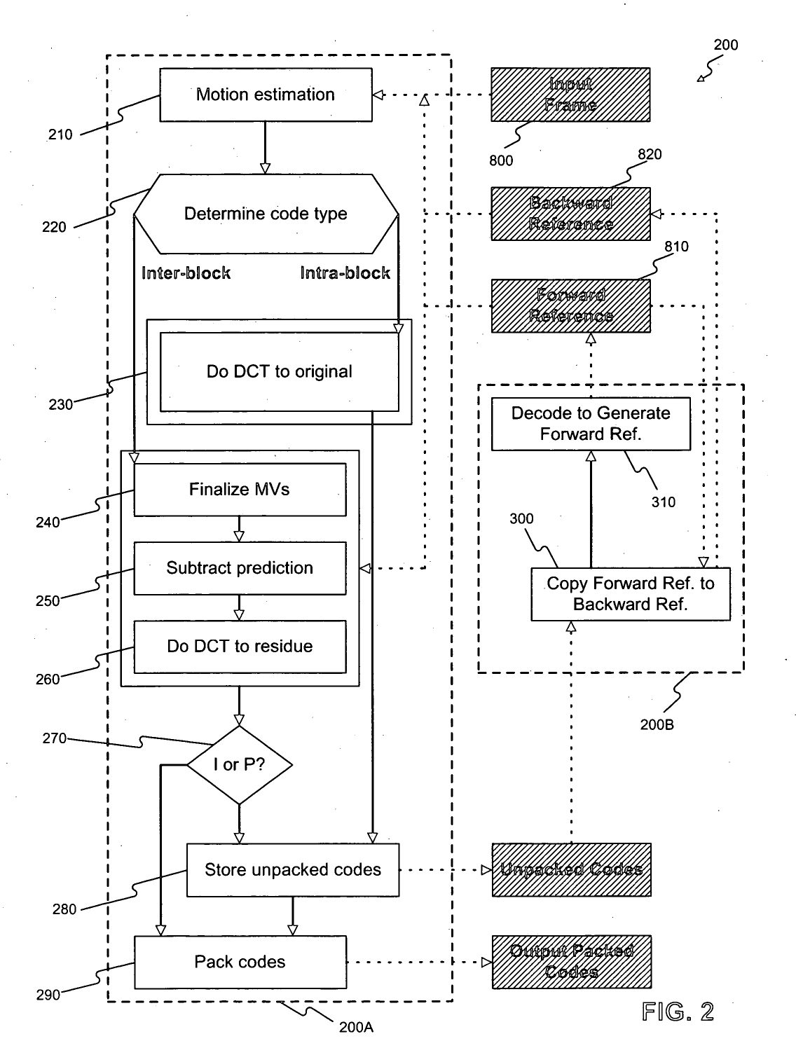

The following will describe an exemplary encoding method that may use the MPEG-2 format and may be implemented with a processing system, such as system 100 of FIG. 1. FIG. 2 shows a flow chart illustrating an encoding method. As shown in FIG. 2, an encoding process 200 may comprise two loops, first loop 200A and second loop 200B. Furthermore, encoding process 200 or any portion of it may be repeated to process multiple macroblocks or multiple frames. In particular, first loop 200A may begin with receiving image data, such as a video frame 800, as an input. The input of video frame 800 may be in a digital YUV format.

After receiving video frame 800, motion estimation occurs in step 210. Motion estimation determines whether a certain image area within the frame has moved between two frames. For example, a block matching technique may be used to determine whether a certain area of the frame is the same as, but displaced from a corresponding area of, a reference frame. After the displacement search, the displacement of the area is estimated and an approximated motion vector describing the direction and amount of motion of the area is calculated in step 210. In one application, the area for a displacement search may be a macroblock. Additionally, the bit cost of coding the motion displacement and the accuracy may be calculated in step 210.

In step 220, it is determined whether to use intra-block codes or inter-block codes to code the frame. As noted above, intra-block codes are codes that do not reference to another macroblock or block, and inter-block codes are codes that reference to the codes of another macroblock or block. For example, in one embodiment, if the results of motion estimation indicate that using inter-block codes to represent the frame would require fewer data bits than using intra-block codes, inter-block codes are to be used. Otherwise, intra-block codes are to be used. If intra-block codes are to be used, step 230 is performed after step 220.

In step 230, DCT (discrete-cosine-transform) coefficients for all 8×8 value sets within the current macroblock are calculated. In one application, DCT is a method of decomposing a set of data into a weighted sum of spatial frequencies, each of the spatial frequencies has a corresponding coefficient. The spatial frequencies are indicative of how fast the data in the block vary from picture element to picture element. In one embodiment, in the decoding process, each spatial frequency pattern is multiplied by its coefficient and the resulting arrays are summed to reconstruct the image of the original 8×8 block.

Furthermore in step 230, the calculated DCT coefficients may also be quantized. In one application, quantization is a process of reducing the precision in representing certain spatial frequencies, thereby reducing the data bits needed to represent a block of data. For example, it may be desirable to represent the coefficients for high spatial frequencies with less precision, especially for the spatial frequencies that human eyes cannot perceive. In one application, a DCT coefficient is quantized by dividing it by a nonzero positive integer, also known as quantization value and rounding the quotient to the nearest integer. A bigger quantization value results in a lower precision of the quantized DCT coefficient, which can be transmitted with fewer bits.

Following step 230, the DCT coefficients, constituting “unpacked” codes, are stored in step 280, and are later decoded to use the frame as a reference frame. In one embodiment, the unpacked codes are stored in a memory device, such as a DRAM. To increase the coding efficiency, the DCT coefficients may be “packed” via Huffman coding in step 290. In one application, the Huffman coding technique is used to generate tables of variable length codes to achieve good coding efficiency. For example, if short codes are used to represent events that occur frequently, the total length of the codes can be reduced to increase the coding efficiency. The codes packed via Huffman coding may be output for storing in a storage media. In one application, those packed codes represent the results of coding process 200 and can later be processed by a decoder to reconstruct the image represented by the original frame 800.

If it is determined in step 220 that inter-block codes are to be used, steps 240-270 are performed after step 220. In step 240, the approximated macroblock motion vectors can be refined and finalized. In one application, step 240 can be a refined process of motion estimation step 210, which estimates the displacement of certain areas. For example, compared to step 210, step 240 may involve a more comprehensive search, such as searching more or all possible motion displacements or using search algorithms that are more accurate. Step 240 of refining and finalizing motion vectors, therefore, may produce motion vectors more accurately describing the direction and amount of motion of a macroblock. In particular, a forward or backward motion vector can be used for a P-frame macroblock, and a combination of two motion vectors, including a forward and a backward motion vectors, can be used for a B-frame macroblock. In one application, step 240 may be combined with motion estimation step 210 and may be an optional step.

Following step 240, a predicted macroblock can be calculated in step 250. In one application, the predicted macroblock is a macroblock that is generated based on the prediction from a reference macroblock and is, therefore, representative of the macroblock that is currently being encoded. For example, the prediction from a reference macroblock can be the result of motion estimate in step 210 or motion vector finalization in step 240. A residue macroblock, indicative of the differences between the original macroblock currently being processed and the predicted macroblock, may then be generated by subtracting the predicted macroblock from the current macroblock.

After the residue macroblock is generated, the DCT coefficients for all 8×8 sets of the residue macroblock are calculated and quantized in step 260. In one application, the DCT-coefficient calculating and quantizing processes described above in relation to step 230 or their variations may be used to generate quantized DCT coefficients.

Following step 260, it is determined in step 270 whether the current frame is an T-frame or P-frame at the macroblock level. If the current frame is an I-or P-frame, it can be used as a reference. Therefore, if the current frame is an I- or P-frame, the DCT coefficients are stored in step 280, to be later decoded to form reference frame. As noted above, the unpacked codes are stored in a memory device, such as a DRAM, in one embodiment. Also as noted above, the DCT coefficients may be packed via Huffman coding in step 290 to increase the coding efficiency. The codes packed via Huffman coding may be output for storing in a storage media and may represent the results of encoding process 200.

In encoding process 200 described above, the code-type-determination step 220 may alternatively be performed after the DCT coefficients are obtained. Therefore, a determination as to whether to use intra-block codes or inter-block codes can alternatively be made after steps 230, 280, or 290.

As noted above, first loop 200A concludes with step 290. First loop 200A may be repeated to process multiple macroblocks of a frame or multiple sets of image data of one or more images.

Second loop 200B, which includes steps 300 and 310, may be performed before step 210 if the current frame is an I- or P-frame, which is determined in step 270. One or more references may be updated with second loop 200B, so that the current I- or P-frame can serve as a reference of other frames. In one application, two references, a Backward Reference frame and a Forward Reference frame, are stored as reference frames in the YUV digital format. These two reference frames may both be updated over time with second loop 200B. For example, to update these two reference frames, the set of codes forming previous Forward Reference frame is copied to become the updated Backward Reference frame in step 300. The set of codes (DCT coefficients) of the current frame obtained from step 280 are decoded in step 310 to become the updated Forward Reference frame.

After updating the Forward and Backward Reference frames with second loop 200B, first loop 200A of encoding process 200 may be repeated to process another macroblock. Forward Reference 810, Backward Reference 820, or both, may be used in motion estimation step 210. In one embodiment, the encoding process illustrated in FIG. 2 may require five or more memory buffers to hold five sets of data, including Input Frame 800, Forward Reference 810, and Backward Reference 820 in YUV format; the unpacked codes stored in step 280; and the packed codes generated in step 290.

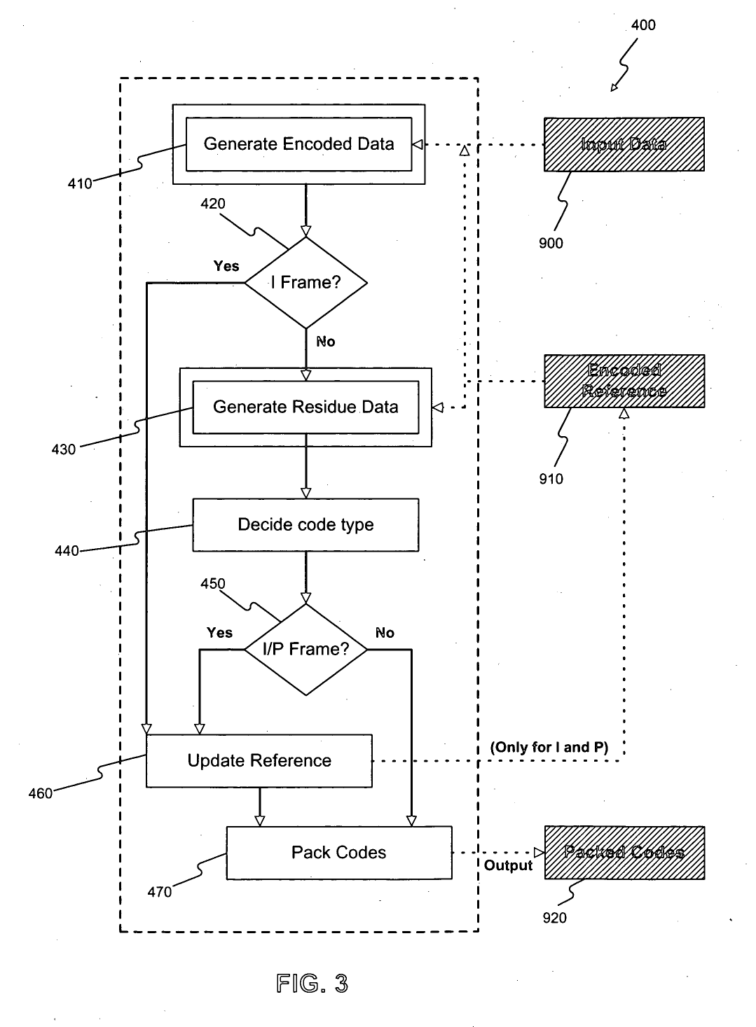

FIG. 3 shows a flow chart illustrating an encoding method consistent with the present invention. In some embodiments, the encoding method may reduce encoding complexity, increase encoding efficiency, and/or achieve real-time encoding. Furthermore, encoding methods consistent with the invention may require less processing and memory resources than conventional encoding methods. In particular, an encoding method consistent with the invention may perform a frequency domain transform of input data before further image codings or processings. Furthermore, embodiments consistent with the invention may encode digital video in various digital-video formats, such as MPEG formats or the MPEG-2 format in particular.

As shown in FIG. 3, encoding process 400 may begin with receiving input data 900 containing image information, such as a video frame. Depending on the standard under which encoding process 400 operates, input data 900 may be in a digital YUV format. In one embodiment, input data 900 may contain the image data of macroblock or a portion of a macroblock, such as one or more 8×8 blocks within a 16×16 macroblock.

After receiving input data 900, encoded data may be generated in step 410 based on a frequency domain transform of input data 900. The frequency domain transform may be a transform for removing less significant information within input data 900. In one embodiment, the transform may remove frequencies not perceivable by or less significant to human eyes or remove image information less relevant to certain applications. For example, the transform may remove frequencies with negligible amplitudes, round frequency coefficients to standard values, or do both. Additionally, one or more transforms may be used in step 410.

In one embodiment, a linear transform or a transform that approximates a linear transform, such as a DCT (discrete cosine transform) or its equivalent, may be used as the frequency domain transform. For example, step 410 may include calculating the DCT coefficients for one or more 8×8 blocks within the current macroblock and quantizing the DCT coefficients.

As noted above in describing step 210 of FIG. 2, DCT is a method of decomposing a block of data into a weighted sum of spatial frequencies. Further quantization of DCT coefficients may reduce the data bits needed to represent a block of data. Therefore, quantized DCT coefficients of input data 900 may be generated in step 410 as the encoded data.

After the encoded data is generated, it is determined in step 420 whether the frame being processed is an I-frame (or an initial image of a group of images) or a P- or B-frame that will use a previously generated reference frame for encoding. For example, when an I-frame or an initial image of a group of images is being processed, no encoded reference is available to be used. If no encoded reference is available, the encoded data generated in step 410 is stored as an updated encoded reference in step 460 for future references. In other words, the encoded data, being initial data or intra-block codes that do not reference to another macroblock, may serve as a reference in processing the next macroblock. In one embodiment, the encoded data comprises quantized DCT coefficients generated in step 410, and the encoded data may be stored in a memory device, such as a DRAM.

Following step 460, the encoded data may be packed in step 470 to increase the coding efficiency. For example, the quantized DCT coefficients from step 410 may be packed via Huffman coding in step 470. In one embodiment, each 8×8 set of values of a 16×16 macroblock may be coded by Huffman coding of quantized DCT coefficients. As noted above, the Huffman coding technique is used to generate tables of variable length codes to achieve good coding efficiency. For example, if short codes are used to represent events that occur frequently, the total code length may be reduced and the coding efficiency may be increased. The codes packed via Huffman coding may be output for storing in a storage media. In one embodiment, the packed codes may be in an MPEG format, such as the MPEG-2 format. Furthermore, those packed codes may represent the results of coding process 400 and be supplied as output data of coding process 400. Therefore, the output data can later be process by a decoder to reconstruct the frame or image coded.

If it is identified in step 420 that the frame being processed is not an I-frame or an initial image of a group of images, the existing (stored) encoded reference may continue to be used in the coding process. As noted above, the encoded reference may be a frequency domain transform of a reference image. In an embodiment of encoding digital video, the encoded reference may be a part of the frame before or immediately before the current frame. In some embodiments, the encoded reference may vary over time or remain the same for a period of time, such as during the processing of several frames.

When the frame currently being processed is a B-frame or a P-frame, residue data is generated in step 430. The residue data represents the difference between the encoded data of the frame currently being processed and the encoded reference. For example, the residue data can be generated using a prediction of the current frame based on an earlier (reference) frame. The residue data may be generated by subtracting the encoded reference from the encoded data of the frame being processed or a prediction. In particular, generating the residue data may involve calculating the difference between the quantized DCT coefficients of input data 900 and the quantized DCT coefficients of a reference image. Furthermore, the residue data may include a motion vector describing the displacement of a certain area, such as describing the direction and amount of motion of a macroblock.

In one embodiment, the residue data generated in step 430 may be based on a backward encoded reference, a forward encoded reference, or both. A backward encoded reference is an encoded reference based on a frame representing an image at a time before the current frame, and a forward encoded reference is an encoded reference based on a frame representing an image at a time after the current frame. In one embodiment, three sets of residue data or motion vector codes, including forward, backward, and bidirectional ones, may be generated. For example, the backward residue data is a prediction of the current frame from an earlier frame, the forward residue data is a prediction of the current frame from a later frame, and the bidirectional residue data is a prediction of the current frame from both an earlier frame and a later frame. Among the three sets of residue data or motion vector codes, the set that contains least data or with the least code length may be used.

Following the step 430, the code type is determined in step 440, that is, it is determined what data is selected for incorporation in output data. In particular, it is determined whether encoded data or residue data will be incorporated in output data. As noted above, the residue data is the prediction of the current frame from the encoded reference, and the encoded data may be the result of a frequency domain transform of input data 900, such as in the form of quantized DCT coefficients. To reduce data bits needed for storing the image of input data 900, the code type using fewer data bits or shorter code length may be selected in step 440. In one embodiment, the quantized DCT coefficients of input data 900 may be compared with the quantized DCT coefficients of the residue data, and the one with a shorter code length may be selected.

After the code type is selected in step 440, step 450 examines whether the frame being processed is an I- or P-frame at the macroblock level. If the frame is an I- or P-frame at the macroblock level, the selected data is stored to become the encoded reference in step 460 for future references. As a result, the selected data may serve as a reference in processing the next macroblock. In one embodiment, the selected data comprises quantized DCT coefficients and may be stored in a memory device, such as a DRAM.

After the code type is selected in step 440 and the reference is updated in step 460, the selected data may be packed in step 470, and the packed codes may be supplied as output data. In one embodiment, the output data is in the form of quantized DCT coefficients, and the quantized DCT coefficients may be packed via Huffman coding to increase the coding efficiency. As noted above, the Huffman coding technique may be used to generate tables of variable length codes to achieve good coding efficiency. For example, if short codes are used to represent events that occur frequently, the total length of the codes can be reduced to increase the coding efficiency. The packed codes generated in step 470 may be stored in a storage media. In one embodiment, the packed codes may be in an MPEG format, such as the MPEG-2 format. Furthermore, those packed codes may represent the results of encoding process 400 and can later be processed by a decoder to reconstruct the frame encoded.

If it is determined in step 450 that the selected data is not an I- or P-frame at the macroblock level, step 460 of storing the selected data as the encoded reference may be omitted. However, the selected data may be packed and supplied as packed codes in step 470, as described above.

According to encoding process 400 described above and shown in FIG. 3, embodiments consistent with the invention may generate encoded data based on the frequency domain transform of input data 900. In one embodiment, generating encoded data before other image codings or processings may reduce the computational complexity involved in motion prediction and in motion search for generating the residue data. It also may avoid the need of decoding a reference before using the reference for motion prediction. In one embodiment, the encoding process may require less memory space, less processing power, or less of both. For example, in embodiments consistent with encoding process 400 shown in FIG. 3, a system may require only three memory buffers to respectfully hold the input data, the encoded reference, and the packed codes.

An encoding method consistent with the invention may encode images represented by data created under one or more digital video standards, using various types of devices, and relying on either hardware or software implementations. For example, encoding instructions may be written in software or control codes. A computer may access the software or the control codes to execute steps embodying an encoding method consistent with the invention. A computer-readable medium such as magnetic, optical, or magnetic-optical discs, hard drives, and various types of memories, can store the software or the control codes for those computing system or devices. Therefore, a computer-readable medium may be configured to contain instructions for instructing a computer to perform one or more of the steps described above. Specifically, the computer may be any types of computing device, such as one with a processor or a microprocessor and a memory device coupled with the processor or the microprocessor. Table I sets forth below pseudo-codes representative of the method of FIG. 3. As an exemplary illustration, the following pseudo-codes include two major loops of an encoding process. One loop encodes a video sequence frame after frame by calling the other loop that compresses one frame at a time by looping through macroblocks.

```
TABLE I
#define M distance_between_two_consecutive_I_or_P_frames // = segment size
#define N distance_between_two_consecutive_I_frames // = GOP size
/**************************************************************************/
int EncodingVideoSequence( )
{
    int err = NO_ERR;
    int Gop1stFrame;
    int FrameCounter = 0;
    int FrameLoopStop = 0;
    PutSequenceHeader( );
    PutSequenceExtension( );
    PutSequenceDisplayExtension( );
    do{ // frame loop
        Gop1stFrame = N*((FrameCounter+(M−1))/N) − (M−1);
        If(Gop1stFrame<0) Gop1stFrame = 0;
// Determine frame type:
        if (FrameCounter == Gop1stFrame){ // I-frame, i.e. 1^{st} frame in a GOP
            PictType = I_TYPE;
            if(FrameCounter == 0){ //1^{st} frame of sequence, thus closed GOP
                TempRef = 0;
                PutGopHeader(Gop1stFrame,CLOSED_GOP);
            }
            else { // starting of an open GOP
                TempRef = M−1;
                PutGopHeader(Gop1stFrame,OPEN_GOP);
            }
        }
        else if((FrameCounter−1)%M == 0){ // P-frame
            PictType = P_TYPE;
            TempRef = FrameCounter + M − 1 − Gop1stFrame;
        }
        else { // B-frame
            PictType = B_TYPE;
            TempRef = FrameCounter − 1 − Gop1stFrame;
        }
// Read new YUV frame and do encoding:
        CurrentYUV = FrameYUV[FrameCounter%M];
        if(FrameType != B_TYPE){ // Load and encode the current I or P frame:
                    if(GetNextFrame( )==NO_MORE_FRAME) FrameLoopStop =
TRUE;
            else if(err = EncodingVideoFrame ( )) return(err);
        }
        else{ // Encode the current B frame and load for the next segment:
            if(err = EncodingVideoFrame ( )) return(err);
            GetNextFrame( );
        }
        FrameCounter++;
    }while(!FrameLoopStop); // Loop of frames
    PutSequenceEnd( );
    return NO_ERR;
}
#define NUM_BLOCKS number_of_blocks_in_a_macroblock
/**************************************************************************/
int EncodingVideoFrame( )
{
    int MBType; // macroblock type
    int MBcbp; // macroblock code block pattern
    short CurrentMB[NUM_BLOCKS*64]; // buffer for current macroblock DCT
    short DiffMB[NUM_BLOCKS*64]; // buffer for macroblock difference DCT
    short *RefMB; // point to buffer for macroblock reference DCT
    PutPictureHeader( );
    PutPictureCodingExtension( );
    int UpdateReference = (FrameType == B_TYPE) ? FALSE : TRUE;
    RefMB = ReferenceDCT;
    for (int j=0; j<HeightMB; j++){
        // New slice
        PutSliceHeader( );
        for (int i=0; i<WidthMB; i++){ // Loop of macroblocks
            // Read the current macroblock from Current_YUV to CurrentMB
            ReadMacroblock(CurrentMB, Current_YUV, i, j);
            // Calculate DCT for a macroblock
            for(int b=0; b<NUM_BLOCKS; b++) ForwardDCT(CurrentMB+b*64);
            // Decide microblock type
            if (FrameType == I_TYPE) MBType = MB_INTRA;
            else{ // Compare efficiencies between original and difference
                CalculateDifferenceMB(DiffMB, CurrentMB, RefMB);
                cost0 = GetCodeCost(CurrentMB);
                cost1 = GetCodeCost(DiffMB);
                if(cost1 >= cost0) MBType = MB_INTRA;
                else MBType = (FrameType==B_TYPE) ? MB_FORWARD : MB_BACKWARD;
            }
            // Do quantization
            if(MBType == MB_INTRA){
                PackMBTypeCode( );
                for(b=0; b<NUM_BLOCKS; b++){
                    QuantizeOriginal(CurrentMB+b*64,UpdateReference);
                    PackIntraBlock(CurrentMB+b*64,b);
                }
            }
            else{
                for(b=0; b<NUM_BLOCKS; b++){
                    QuantizeDiffAndGetMBcbp(DiffMB+b*64,UpdateReference);
                }
                PackMBTypeCode( );
                for(b=0; b<NUM_BLOCKS; b++){
                    if(MBcbp&(1<<(5−b))) PackInterBlock(DiffMB+b*64,b);
                }
            }
            RefMB += NUM_BLOCKS*64;
        } // i − MB column
    } // j − MB row
    AlignByte( );
    return NO_ERR;
}
```

For example, a system as shown in FIG. 1 may operate in a way consistent with encoding process 400 noted above and shown in FIG. 3. The following will describe an embodiment using a processing system to implement steps consistent with encoding process 400.

As shown in FIG. 1, to encode data representing an image or a frame of a digital video, processor 110 may be configured to receive input data containing image information. Processor 110 may also be configured to execute the method of FIG. 3 and generate encoded data based on the frequency domain transform of the input data. When an encoded reference is available in memory 120, processor 110 generates residue data representing the difference between the encoded data and the encoded reference. When no encoded reference is available in memory 120, processor 110 may store the encoded data in memory 120 as an updated encoded reference. Processor 110 may use the updated encoded reference for comparing with or processing later macroblocks.

After generating the residue data, processor 110 may select one of the encoded data and the residue data to be incorporated in output data. For example, processor 110 may select the smaller of the encoded data and the residue data to be incorporated in the output data. When the encoded data is selected, processor 110 may store the encoded data in memory 120 as the encoded reference. After processor 110 selects data for incorporation, processor 110 may generate packed codes from the selected data, such as via Huffman coding, to be supplied as output data.

Accordingly, embodiments consistent with the invention may provide an encoding system or method that works in a transform domain, such as a DCT encoded domain, and may avoid having a decoder to control quality drift. Embodiments consistent with the invention may also reduce the usage of memory space, processing power, or both, thereby providing an encoding method or system with high speed, low complexity, low memory usage, and/or low CPU usage. For example, wireless devices, portable devices, and other consumer electronic products may employ methods or systems consistent with the present invention to achieve real-time or near real-time encoding, to reduce hardware costs, or to accomplish both goals.

Although some embodiments above have been described with encodings using the MPEG-2 or MPEG formats as input, embodiments consistent with the invention may use various digital video formats. Furthermore, as noted above, embodiments consistent with the invention may rely on either hardware or software implementations. For example, a device consistent with the invention, such as a camcorder, a digital camera, or other digital image processing devices, may incorporate a video or image encoding chip using an encoding system or method described above.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An MPEG-2 encoding method comprising:
receiving input data containing image information;
generating encoded data based on a frequency domain transform of the input data;
determining whether an encoded reference is available for use;
generating residue data representing the difference between the encoded data and the encoded reference when the encoded reference is available; and
storing the encoded data as an encoded reference when no encoded reference is available.

2. The method of claim 1, further comprising:
selecting one of the encoded data and the residue data for incorporation in output data; and
when the encoded data is selected, storing the encoded data as the encoded reference.

3. The method of claim 2, wherein selecting one of the encoded data and the residue data comprises selecting the smaller of the encoded data and the residue data.

4. The method of claim 2, further comprising generating packed codes from the selected data and supplying the packed codes as output data.

5. The method of claim 4, comprising supplying the packed codes as the output data in an MPEG format.

6. The method of claim 1, wherein the frequency domain transform comprises a discrete cosine transform.

7. A system comprising:
a processor configured to:
receive input data containing image information,
generate encoded data based on a frequency domain transform of the input data, and
selectively generate an encoded reference based on a frequency domain transform of the input data; and
a memory device coupled to the processor;
wherein the processor is further configured to:
store the generated encoded reference in the memory device when no encoded reference is available in the memory device, and
generate residue data representing the difference between the encoded data and the stored encoded reference when the encoded reference is available in the memory device.

8. The system of claim 7, wherein the processor is configured to:
select one of the encoded data and the residue data for incorporation into output data; and
store the encoded data as the encoded reference in the memory device when the encoded data is selected.

9. The system of claim 8, wherein the processor is configured to select the smaller of the encoded data and the residue data as the output data.

10. The system of claim 8, wherein the processor is configured to generate packed codes from the selected data.

11. The system of claim 10, wherein the processor is configured to generate the packed codes in an MPEG format.

12. The system of claim 7, wherein the frequency domain transform comprises a discrete cosine transform.

13. The system of claim 7, wherein the processor is configured to
receive the input data in the form of I, P, or B frames; and
generate an encoded reference based on a frequency domain transform of the input data only when the received input data is in the form of an I or P frame.

14. The system of claim 13, wherein the processor is configured to generate quantized data from the encoded data.

15. The system of claim 14, wherein the processor is configured to generate the quantized data consistent with the MPEG-2 format.

16. A computer-readable medium containing instructions for a computer to encode image information, the computer-readable medium instructing the computer to:
receive input data containing image information;
generate encoded data based on a frequency domain transform of the input data;
determine whether an encoded reference is available for use;
generate residue data representing the difference between the encoded data and the encoded reference when the encoded reference is available; and
store the encoded data as an encoded reference when no encoded reference is available.

17. The computer-readable medium of claim 16, wherein the computer-readable medium further instructs the computer to:
select one of the encoded data and the residue data for incorporation in output data; and
store the encoded data as the encoded reference when the encoded data is selected.

18. The computer-readable medium of claim 17, wherein selecting one of the encoded data and the residue data comprises selecting the smaller of the encoded data and the residue data.

19. The computer-readable medium of claim 17, wherein the computer-readable medium further instructs the computer to generate packed codes from the selected data and supply the packed codes as output data.

20. The computer-readable medium of claim 19, wherein the computer-readable medium further instructs the computer to supply the packed codes in an MPEG format.

21. The computer-readable medium of claim 16, wherein the frequency domain transform comprises a discrete cosine transform.

22. The computer-readable medium of claim 16, wherein the computer comprises a processor and a memory device coupled with the processor.
